(19) United States
(12) Patent Application Publication
(10) Pub. No.: US 2020/0182781 A1
(43) Pub. Date: Jun. 11, 2020

(54) MOBILE SPECTRUM ANALYZER SYSTEMS AND METHODS

(71) Applicant: Kerloss Sadek, Lake Forest, CA (US)

(72) Inventor: Kerloss Sadek, Lake Forest, CA (US)

(21) Appl. No.: 16/215,268

(22) Filed: Dec. 10, 2018

(51) Int. Cl. G01N 21/359; G01N 21/65

(52) U.S. Cl. CPC G01N 21/359; G01N 2021/3595; G01N 21/65

(57) ABSTRACT

Mobile Fourier transform near-infrared (FT-NIR), FT-mid-infrared (FT-MIR), and Raman spectral analysis systems that are compact and able to operate with a self-contained power supply are disclosed. The systems are reliable and lend themselves to use in monitoring against counterfeiting of materials including, especially, drugs and medications. Unique spectral identifiers associated with genuine materials can be compared with non-destructive scan results using a handheld and compact apparatus to determine whether product is genuine or not. Additionally, computationally intensive analysis of scanned results can be performed through the use of remote computing resources linked to the mobile spectrum analyzer, such that the mobile spectrum analyzer can be maintained compact, power efficient, and portable while still providing access to all the benefits of FT-NIR, FT-MIR, and Raman analysis.

### BACKGROUND OF THE INVENTION

### 1. Field of the Invention

The present invention relates to spectrum analyzers, and more particularly to a compact mobile spectrum analyzer and systems and methods for use of the mobile spectrum analyzer in ensuring drug, medication, and other material quality control and authentication and in preventing counterfeiting.

### 2. Background and Related Art

Fourier transform near-infrared (FT-NIR) spectroscopy has become a preferred method for use in producing and analyzing a variety of materials, including in industrial settings such as plastic and polymer production. FT-NIR spectroscopy is advantageous in that it permits noninvasive and nondestructive analysis to be performed, including in situ within glass or polymer containers. FT-NIR is a nondestructive chemical analysis technology that does not rely on wet chemical or other reagent methods of testing, and requires little to no sample preparation or hazardous chemicals.

Instead, FT-NIR systems measure the absorption of near-infrared light by the sample at different wavelengths. The recorded near-infrared spectrum is categorized according to the combinations of molecular vibrations of molecules containing carbon-hydrogen, nitrogen-hydrogen, or oxygen-hydrogen groups/bonds. Accordingly, FT-NIR spectroscopy is particularly suited for analysis of organic materials in industries such as pharmaceuticals, chemicals, food, and agriculture. Fourier Transform spectrometers provide high accuracy with respect to wavelength/frequency.

Because glass is transparent in the near-infrared spectrum, near-infrared spectroscopy can be performed in or on a variety of glass materials or objects. FT-NIR spectroscopy can be used for a variety of purposes, such as component or raw material identification, identification of quantities of components in a mixture, and the like.

Despite the advantages of FT-NIR spectroscopy, there are significant impediments to its implementation other than in an industrial setting. Equipment cost and equipment size are among the considerations that hinder wider adoption of FT-NIR spectroscopy.

### BRIEF SUMMARY OF THE INVENTION

Implementation of the invention provides mobile Fourier transform near-infrared (FT-NIR) mid-infrared (FT-MIR), and Raman spectral analysis systems that are compact and able to operate with a self-contained power supply. The systems are reliable and lend themselves to use in monitoring against counterfeiting of materials including, especially, drugs and medications. Unique spectral identifiers associated with genuine materials can be compared with non-destructive scan results using a handheld and compact apparatus to determine whether product is genuine or not. Additionally, computationally intensive analysis of scanned results can be performed through the use of remote computing resources linked to the mobile spectrum analyzer, such that the mobile spectrum analyzer can be maintained compact, power efficient, and portable while still providing access to all the benefits of FT-NIR analysis.

Certain implementations of the invention provide custom-made radio-frequency identification (RFID) near field communication (NFC), and 1D/2D barcode tags which may be affixed to a container containing a material, such as a medication container, where the tag serves as a deterrent and detection device against counterfeiting. Each tag contains information identifying a unique spectral identifier associated with genuine material, whereby the tag can be scanned to determine what unique spectral identifier should be expected if the material within the container is genuine and/or still potent. Thereafter, the material can be scanned using the mobile spectrum analyzer and the results of the scan compared to the expected unique spectral identifier to provide an indication as to whether the material is genuine and/or still potent or not.

According to certain implementations of the invention, a mobile spectral analysis system includes a mobile spectrum analyzer having a self-contained power supply including a battery and a mobile computing device communicative connected to the mobile spectrum analyzer and operating an application configured to control scanning by the mobile spectrum analyzer and to receive scan data from the mobile spectrum analyzer. Processing of the scan data from the mobile spectrum analyzer is moved off of the mobile spectrum analyzer such that the mobile spectrum analyzer is made small and light enough to be readily handheld.

The mobile spectrum analyzer and the mobile computing device may be connected by a wireless connection. The mobile computing device may be communicatively coupled to remote computing resources over a network, such that at least some processing of the scan data from the mobile spectrum analyzer is moved off the mobile device to the remote computing resources. The remote computing resources may include a database of scan data associated with known materials. Processing of the scan data from the mobile spectrum analyzer by the remote computing resources may include performing a comparison of entries from the database of scan data and the scan data from the mobile spectrum analyzer.

The mobile spectral analysis system may further include a tag such as a radio-frequency identification (RFID) tag, a near field communication (NFC) tag, or an optical tag. The tag may be affixed to a container containing a material to be tested, and the tag may contain information identifying a unique spectral identifier that should be the result of the scan data from the mobile spectrum analyzer if the material within the container is genuine. The mobile computing device may include a RFID reader adapted to read the RFID tag. The mobile computing device may include a NFC reader adapted to read the NFC tag. The mobile computing device may include an optical reader adapted to read the optical tag. The mobile computing device may be configured to obtain the information identifying the unique spectral identifier and to perform a comparison between the unique spectral identifier and the scan data from the mobile spectrum analyzer and provide an indication regarding whether the material within the container is genuine.

The indication regarding whether the material within the container is genuine may be or include a binary indication. The indication regarding whether the material within the container is genuine may be or include a graphical comparison between the unique spectral identifier and the scan data from the mobile spectrum analyzer. The indication regarding whether the material within the container is genuine may be or include an assurance level of the probability that the material within the container is genuine. The NFC tag may include a structure adapted to be broken if the container is opened and a capability of notifying the mobile computing device when the structure adapted to be broken has been broken.

The mobile spectrum analyzer may be a Fourier transform near-infrared (FT-NIR) spectrum analyzer, a Fourier transform mid-infrared (FT-MIR) spectrum analyzer, a Raman spectrum analyzer, and/or any other suitable analyzer. The mobile spectrum analyzer may include a light source such as a FT-NIR-compatible light source, a FT-MIR-compatible light source, a Raman-spectroscopy-compatible light source, and/or any other suitable light source. The mobile spectrum analyzer may include a sensor such as a FT-NIR-compatible sensor, a FT-MIR-compatible sensor, a Raman-spectroscopy-compatible sensor, and/or any other suitable sensor.

In some embodiments, the mobile spectrum analyzer comprises a FT-NIR spectrum analyzer or a FT-MIR spectrum analyzer, includes a light source such as a FT-NIR-compatible light source or a FT-MIR-compatible light source, and includes a sensor such as a a FT-NIR-compatible sensor or a FT-MIR-compatible sensor.

According to further implementations of the invention, a method is provided for using a mobile spectrum analyzer communicatively connected with a mobile computing device to nondestructively conduct a spectral analysis of a material. Some implementations of the method include steps of communicatively coupling a mobile spectrum analyzer having a self-contained power supply including a battery to a mobile computing device, placing a material to be analyzed within a test chamber of the mobile spectrum analyzer, exposing the material within the test chamber of the mobile spectrum analyzer to light within a selected electromagnetic spectrum, and detecting a spectrum of light returned from the material using a sensor of the mobile spectrum analyzer. The method also includes steps of communicating information regarding the spectrum of light detected by the sensor of the mobile spectrum analyzer to the mobile computing device and processing the information regarding the spectrum of light detected by the sensor of the mobile spectrum analyzer to generate information regarding the material within the test chamber of the mobile spectrum analyzer.

Some implementations of the method further include a step of using the mobile computing device to obtain information regarding the material to be analyzed from a tag affixed to packaging originally containing the material to be analyzed. The tag may be a tag such as a RFID tag, a NFC tag, a one-dimensional optical tag, a two-dimensional optical tag, and/or any other suitable tag.

The information regarding the material to be analyzed may include an intended unique spectral identifier associated with a material that is supposed to be contained within the packaging. The step of processing the information regarding the spectrum of light detected by the sensor of the mobile spectrum analyzer to generate information regarding the material within the test chamber of the mobile spectrum analyzer may include comparing an actual unique spectral identifier associated with the material within the test chamber with the intended unique spectral identifier to verify authenticity of the material within the test chamber.

The step of processing the information regarding the spectrum of light detected by the sensor of the mobile spectrum analyzer to generate information regarding the material within the test chamber of the mobile spectrum analyzer may be performed at least in part by the mobile computing device. The step of processing the information regarding the spectrum of light detected by the sensor of the mobile spectrum analyzer to generate information regarding the material within the test chamber of the mobile spectrum analyzer may be performed at least in part by a remote computing resource in communication with the mobile computing device. The mobile computing device may communicate at least a portion of the information regarding the spectrum of light detected by the sensor of the mobile spectrum analyzer to the remote computing resource.

According to additional implementations of the invention, a method for verifying authenticity of a material stored in a sealed container includes steps of using a spectrum analyzer to determine original spectral data associated with an original material to be contained in a sealed original container, assigning an original unique spectral identifier to the spectral data, storing the original unique spectral identifier on a network-connected server system along with the original spectral data, placing the original material into an original container, burning information identifying the original spectral data and the original unique spectral identifier into an original sealing tag, and sealing the container with the original sealing tag. The method also includes a step of receiving, over the network, a request to verify authenticity of material in an endpoint container. The request includes information identifying an endpoint unique spectral identifier obtained from an endpoint tag affixed to and sealing the endpoint container and endpoint spectral data obtained from the endpoint tag. The method further includes a step of sending, over the network, a response to the request. The response is either a verification that the material in the endpoint container is authentic if the endpoint unique spectral identifier and the endpoint spectral data match the original unique spectral identifier and the original spectral data or an indication that the material in the endpoint container is not authentic if either of the endpoint unique spectral identifier or the endpoint spectral data does not match the original unique spectral identifier or the original spectral data.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computing environment for use with embodiments of the present invention;

FIG. 2 shows a representative networked computing environment for use with embodiments of the present invention;

FIG. 3 shows a front view of a representative mobile spectrum analyzer with a calibrator cap affixed thereto;

FIG. 4 shows a perspective view of the mobile spectrum analyzer of FIG. 3 with the calibrator cap affixed thereto;

FIG. 5 shows a side view of the mobile spectrum analyzer of FIG. 3 with the calibrator cap affixed thereto;

FIG. 6 shows a side view of the mobile spectrum analyzer of FIG. 3 with the calibrator cap removed;

FIG. 7 shows a front view of the mobile spectrum analyzer of FIG. 3 with the calibrator cap removed and the sensor exposed;

FIG. 8 shows a perspective view of the sensor area of the mobile spectrum analyzer of FIG. 3;

FIG. 9 shows an exploded view of a representative calibrator cap;

FIG. 10 shows an exploded view of a representative pill tray;

FIG. 11 shows an exploded view of a representative liquid tray;

FIG. 12 shows a perspective view of the mobile spectrum analyzer of FIG. 3 as the calibrator cap of FIG. 9 is being removed;

FIG. 13 shows a perspective view of the mobile spectrum analyzer of FIG. 3 as the pill tray of FIG. 10 is being used;

FIG. 14 shows a perspective view of the mobile spectrum analyzer of FIG. 3 as the liquid tray of FIG. 11 is being used;

FIG. 15 shows a view of the mobile spectrum analyzer of FIG. 3 proximate a mobile computing device;

FIG. 16 shows a representative radio-frequency identification (RFID)/near field communication (NFC) tag;

FIG. 17 shows a representative display of information related to unique spectral identifier of a medication;

FIG. 18 shows a representative illustration of using a mobile device to scan a RFID/NFC tag affixed to a medication container;

FIG. 19 shows a representative display on a mobile device;

FIG. 20 shows a representative display on a mobile device;

FIG. 21 shows a representative display on a mobile device; and

FIG. 22 shows a representative display of information related to results of a Fourier transform near-infrared (FT-NIR) scan of a counterfeit product as opposed to expected results for a genuine product.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

According to certain embodiments of the invention, a mobile spectral analysis system includes a mobile spectrum analyzer having a self-contained power supply including a battery and a mobile computing device communicatively connected to the mobile spectrum analyzer and operating an application configured to control scanning by the mobile spectrum analyzer and to receive scan data from the mobile spectrum analyzer. In accordance with some embodiments, processing of the scan data from the mobile spectrum analyzer is moved off of the mobile spectrum analyzer such that the mobile spectrum analyzer is made small and light enough to be readily handheld.

The mobile spectrum analyzer and the mobile computing device may be connected by a wireless connection. The mobile computing device may be communicatively coupled to remote computing resources over a network, such that (in some embodiments) at least some processing of the scan data from the mobile spectrum analyzer is moved off the mobile device to the remote computing resources. The remote computing resources may include a database of scan data associated with known materials. Processing of the scan data from the mobile spectrum analyzer by the remote computing resources may include performing a comparison of entries from the database of scan data and the scan data from the mobile spectrum analyzer.

The mobile spectral analysis system may further include a tag such as a radio-frequency identification (RFID) tag, a near field communication (NFC) tag, an optical tag, and/or any other suitable tag. The tag may be affixed to a container containing a material to be tested, and the tag may contain information identifying a unique spectral identifier that should be the result of the scan data from the mobile spectrum analyzer if the material within the container is genuine. The mobile computing device may include a RFID reader adapted to read the RFID tag. The mobile computing device may include a NFC reader adapted to read the NFC tag. The mobile computing device may include an optical reader adapted to read the optical tag. The mobile computing device may be configured to obtain the information identifying the unique spectral identifier and to perform a comparison between the unique spectral identifier and the scan data from the mobile spectrum analyzer and provide an indication regarding whether the material within the container is genuine.

In some embodiments, the indication regarding whether the material within the container is genuine is or includes a binary indication. In some cases, the indication regarding whether the material within the container is genuine is or includes a graphical comparison between the unique spectral identifier and the scan data from the mobile spectrum analyzer. In some cases, the indication regarding whether the material within the container is genuine is or includes an assurance level of the probability that the material within the container is genuine. The NFC tag may include: a structure adapted to be broken, damaged, or to otherwise indicate if the container is opened, and a capability of notifying the mobile computing device when the structure adapted to be broken has been broken.

The mobile spectrum analyzer may be a Fourier transform near-infrared (FT-NIR) spectrum analyzer, a Fourier transform mid-infrared (FT-MIR) spectrum analyzer, a Raman spectrum analyzer, and/or any other suitable analyzer. The mobile spectrum analyzer may include a light source such as a FT-NIR-compatible light source, a FT-MIR-compatible light source, a Raman-spectroscopy-compatible light source, and/or any other suitable light source. The mobile spectrum analyzer may include a sensor such as a FT-NIR-compatible sensor, a FT-MIR-compatible sensor, a Raman-spectroscopy-compatible sensor, and/or any other suitable sensor.

In some embodiments, the mobile spectrum analyzer comprises one or more FT-NIR spectrum analyzers or FT-MR spectrum analyzers, includes one or more light sources such as a FT-NIR-compatible light source or a FT-MIR-compatible light source, and includes one or more sensors such as a FT-NIR-compatible sensor or a FT-MIR-compatible sensor.

According to further embodiments of the invention, a method is provided for using a mobile spectrum analyzer communicatively connected with a mobile computing device to nondestructively conduct a spectral analysis of a material. The method includes steps of communicatively coupling a mobile spectrum analyzer having a self-contained power supply including a battery (and/or any other suitable power supply, such as a plug to the mains) to a mobile computing device, placing a material to be analyzed within a test chamber of the mobile spectrum analyzer, exposing the material within the test chamber of the mobile spectrum analyzer to light within a selected electromagnetic spectrum, and detecting a spectrum of light returned from the material using a sensor of the mobile spectrum analyzer. The method also includes steps of communicating information regarding the spectrum of light detected by the sensor of the mobile spectrum analyzer to the mobile computing device (and/or any other suitable computing device) and processing the information regarding the spectrum of light detected by the sensor of the mobile spectrum analyzer to generate information regarding the material within the test chamber of the mobile spectrum analyzer.

In accordance with some embodiments, the method further includes a step of using the mobile computing device to obtain information regarding the material to be analyzed from a tag affixed to packaging originally containing the material to be analyzed. The tag may be a tag such as a RFID tag, a NFC tag, a one-dimensional optical tag, a two-dimensional optical tag, and/or any other suitable tag.

The information regarding the material to be analyzed may include an intended unique spectral identifier associated with a material that is supposed to be contained within the packaging. The step of processing the information regarding the spectrum of light detected by the sensor of the mobile spectrum analyzer to generate information regarding the material within the test chamber of the mobile spectrum analyzer may include comparing an actual unique spectral identifier associated with the material within the test chamber with the intended unique spectral identifier to verify authenticity of the material within the test chamber.

The step of processing the information regarding the spectrum of light detected by the sensor of the mobile spectrum analyzer to generate information regarding the material within the test chamber of the mobile spectrum analyzer is (in some embodiments) performed at least in part by the mobile computing device (and/or any other suitable computing device, including, without limitation, a computing device in the mobile spectrum analyzer). The step of processing the information regarding the spectrum of light detected by the sensor of the mobile spectrum analyzer to generate information regarding the material within the test chamber of the mobile spectrum analyzer may be performed at least in part by a remote computing resource in communication with the mobile computing device. The mobile computing device may communicate at least a portion of the information regarding the spectrum of light detected by the sensor of the mobile spectrum analyzer to the remote computing resource.

According to additional embodiments of the invention, a method for verifying authenticity of a material stored in a sealed container includes steps of using a spectrum analyzer to determine original spectral data associated with an original material to be contained in a sealed original container, assigning an original unique spectral identifier to the spectral data, storing the original unique spectral identifier on a network-connected server system along with the original spectral data, placing the original material into an original container, burning information identifying the original spectral data and the original unique spectral identifier into an original sealing tag, and sealing the container with the original sealing tag. The method also includes a step of receiving, over the network, a request to verify authenticity of material in an endpoint container. The request includes information identifying an endpoint unique spectral identifier obtained from an endpoint tag affixed to and sealing the endpoint container and endpoint spectral data obtained from the endpoint tag. The method further includes a step of sending, over the network, a response to the request. The response is either a verification that the material in the endpoint container is authentic if the endpoint unique spectral identifier and the endpoint spectral data match the original unique spectral identifier and the original spectral data or an indication that the material in the endpoint container is not authentic if either of the endpoint unique spectral identifier or the endpoint spectral data does not match the original unique spectral identifier or the original spectral data.

Embodiments of the invention provide mobile Fourier transform near-infrared (FT-NIR) spectral analysis systems (and/or other suitable spectral analysis systems) that are compact and able to operate with a self-contained power supply (and/or any other suitable power supply). The systems are reliable and lend themselves to use in monitoring against counterfeiting of materials including, especially, drugs and medications. Unique spectral identifiers associated with genuine materials can be compared with non-destructive scan results using a handheld and compact apparatus to determine whether product is genuine or not. Additionally, computationally intensive analysis of scanned results can (in some embodiments) be performed through the use of remote computing resources linked to the mobile spectrum analyzer, such that the mobile spectrum analyzer can be maintained compact, power efficient, and portable while still providing access to all the benefits of FT-NIR analysis.

Certain embodiments of the invention provide custom-made optical or wirelessly read tags which may be affixed to a container containing a material, such as a medication container, where the tag serves as a deterrent and detection device against counterfeiting. In some embodiments, each tag contains information identifying a unique spectral identifier associated with genuine material, whereby the tag can be scanned to determine what unique spectral identifier should be expected if the material within the container is genuine and/or still potent. The information contained on the tag can be compared to information contained in an online database to confirm a match between the spectral identifier information contained on the tag and the online spectral identifier information to confirm authenticity of the tag and the contained material. In some cases, this can be used even without the mobile spectrum analyzer as a verification process for authenticity using an inexpensive or free verification application operating on a mobile computer device (and/or any other suitable computing device), such as a smart phone. Thereafter, if the mobile spectrum analyzer is available, the material can be scanned using the mobile spectrum analyzer and the results of the scan compared to the expected unique spectral identifier to provide a further and verified indication as to whether the material is genuine and/or still potent or not.

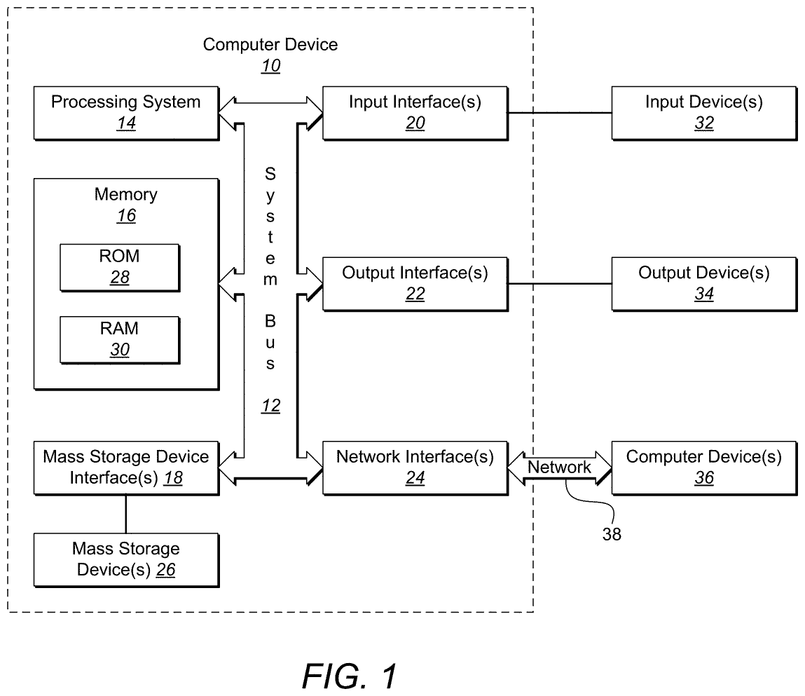

As embodiments of the invention embrace the user of computer systems to enhance the functionality of a mobile spectrum analyzer, FIG. 1 and the corresponding discussion are intended to provide a general description of a suitable computer operating environment in which or with which embodiments of the invention may be implemented. One skilled in the art will appreciate that embodiments of the invention may be practiced by one or more computing devices and in a variety of system configurations, including in a networked configuration. However, while the methods and processes of the present invention can be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing or for use with implementing embodiments of the invention includes computer device 10, which may be a general-purpose or special-purpose computer or any of a variety of consumer electronic devices. For example, computer device 10 may be a personal computer, a notebook or laptop computer, a netbook, a personal digital assistant (“PDA”) or other hand-held device, a smart phone, a tablet computer, a workstation, a minicomputer, a mainframe, a supercomputer, a multi-processor system, a network computer, a processor-based consumer electronic device, a computer device integrated into another device or vehicle, or the like. In a typical use case, computer device 10 may be a mobile device such as a smart phone operating an application adapted to exchange information with a mobile spectrum analyzer, e.g. through a wireless data connection such as a Bluetooth (and/or any other suitable wireless) connection.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a solid-state storage device, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include solid state drives, hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a touch screen, mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. Other examples of network interfaces include wireless devices for communicating via near-field communication (NFC), Bluetooth, and the like. The network interface 24 or interfaces 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

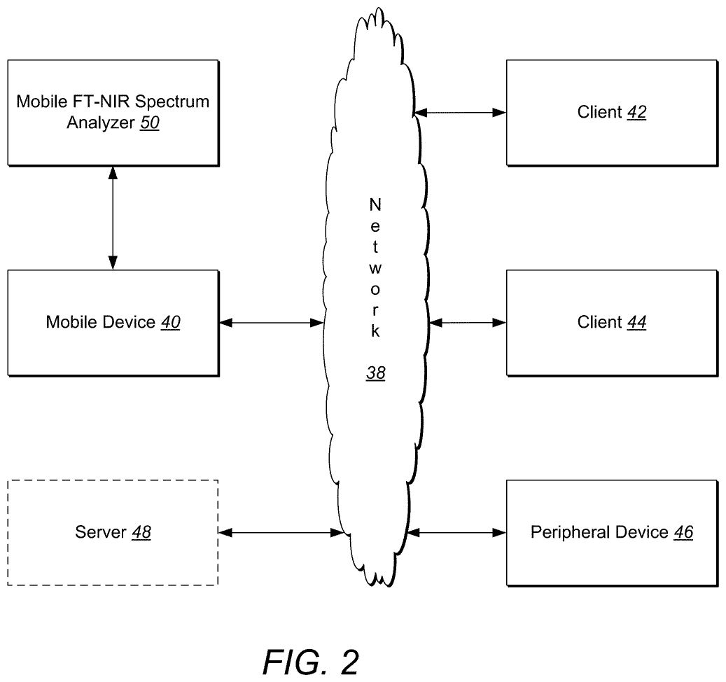

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as mobile device 40, which is connected to one or more other computer devices (illustrated as client 42 and client 44) and one or more peripheral devices 46 across network 38. While FIG. 2 illustrates an embodiment that includes a mobile device 40, two additional clients, client 42 and client 44, one peripheral device 46, and optionally a server 48, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, as shown in FIG. 2, the mobile device 40 may be a computer device having a limited set of hardware and/or software resources. Because the mobile device 40 is connected to the network 38, it may be able to access hardware and/or software resources provided across the network 38 by other computer devices and resources, such as client 42, client 44, server 48, or any other resources. The mobile device 40 may access these resources through an access program, and the results of any computer functions or resources may be delivered through the access program to the user of the mobile device 40. In such configurations, the mobile device 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

The mobile device 40 of FIG. 2 is shown as being communicatively connected to a mobile spectrum analyzer 50. The mobile spectrum analyzer 50 in this example uses FT-NIR spectroscopy, FT-MIR spectroscopy, Raman spectroscopy, and/or any other suitable form of spectroscopy to analyze the spectral response of light absorbed by test materials. The connection between the mobile device 40 and the mobile spectrum analyzer 50 may be wired or wireless, and the communicative connection allows the mobile device 40 to perform computational functions or analysis using information received from the mobile spectrum analyzer 50. Accordingly, because certain functions relating to spectrum analysis need not (necessarily) be contained within or performed by the mobile spectrum analyzer 50 itself, the size of the mobile spectrum analyzer 50 can be minimized. Similarly, as discussed above, because the mobile device 40 may be connected through the network 38 to additional computational resources, the mobile device 40 need not (though in some embodiments it does) contain all information and need not perform (though in some embodiments it can perform) all computational functions necessary for analysis of the detected spectral response.

For example, the server 48 (or servers 48) may include one or more databases of known spectral responses for various materials intended to be tested by the mobile spectrum analyzer 50. The one or more databases could be continually updated with up-to-date information relating to materials subject to testing. Then, when the mobile spectrum analyzer 50 is used to test a new material, the measured spectral response can be transmitted to the mobile device 40, such as using a Bluetooth connection (and/or through any other suitable form of communication), and the mobile device 40 can then transmit either the measured spectral response, portions of the measured spectral response, and/or unique identifying characteristics of the measured spectral response (e.g., after some analysis performed by an application or app running on the mobile device 40) through the network 38 to the server 48 or servers 48.

The server 48 or servers 48 and/or systems associated with the server 48 or servers 48 can take the information received from the mobile device 40 and can relatively quickly perform a comparison with known spectral responses stored on the one or more databases to identify a matching spectral response, identify types and quantities of materials contained within an analyzed substance, and the like, and can send information and/or reports back to the mobile device 40 for display to the user. The server 48 or servers 48 and any systems associated with the server 48 or servers 48 may include artificial intelligence and machine learning systems to facilitate rapid and proper identification of materials and material compositions from incoming scan information. In some instances, the database(s) of information may be updated with new information as a result of new scans performed by manufacturers, as well as a result of new scans performed by non-manufacturer end users as scans are processed by the artificial intelligence and/or machine learning systems.

The information sent back to the mobile device 40 can vary depending on the situation and intended use, but may include information such as verification of whether the spectral response of the tested material matches a spectral response of a known material, verification of whether the spectral response of the tested material matches an expected response (e.g., in a case where the mobile spectrum analyzer 50 is used to test whether a material, such as a medication, is counterfeit or genuine), or any other similar information. In accordance with some embodiments, the mobile device 40 may be used to display the received report, so that some embodiments of the mobile spectrum analyzer 50 optionally do not include a display or may be limited to only a minimal display, such as a limited number of status lights, LEDs, etc., further reducing the size of the mobile spectrum analyzer 50.

In another exemplary use case, the mobile device 40 may perform any necessary comparison steps, but may still optionally utilize remote computing resources over the network 38 (or otherwise) to obtain information for the comparison. By way of example, if the system is being used to determine whether a prescription medication is genuine or not, the mobile device 40 may be manipulated by the user to select or input the name of the medication being tested, whereupon the mobile device 40 communicates with the server 48 over the network 38 to obtain an expected spectral response or profile for the medication. Then, when the mobile spectrum analyzer 50 is used to test the medication, the mobile device 40 may make any necessary comparisons between the actual spectral response and the expected spectral response, thereafter reporting to the user of the mobile device 40 using its display screen. In some instances, the mobile device 40 may be used to send a report of the results of the analysis over the network 38 to the server 48 for further use and/or storage.

In another use case, the mobile device 40 may again perform any necessary comparison steps or it may offload some comparison steps to remote computing resources, but may obtain information for the comparison locally, such as from a marking or device affixed to the material being tested. Such information may be obtained optically, such as using a camera (and/or other sensor) of the mobile device 40 to optically read a 1D or 2D optical tag, or it may be received using a radio-frequency identification (RFID)/near field communication (NFC) connection between the mobile device 40 and a RFID/NFC tag installed on or near the material to be tested, as will be discussed in more detail with respect to the pharmaceutical industry below. The NFC tag may, for example, include expected spectral response information (such as a spectral response graph or individual identifying wavelength measurements) sufficient to allow the mobile device 40 to make the necessary comparison between the expected response and the actual measured response in a verification check. Alternately, the NFC tag or an optical identifier (e.g., a QR code or 1D bar code) affixed to the material to be tested or its container may contain information directing the mobile device 40 to a particular database entry stored on the server 48 (and/or in any other suitable location), such that the mobile device 40 can retrieve such information or can direct or target the comparison performed by the remote computing resources.

The information displayed by the mobile device 40 after any test or comparison, regardless of the extent to which analysis is performed remotely, may be tailored to the individual needs at the point of use. As one example, the mobile device 40 may simply display a binary indication (e.g., pass/fail, good/bad, go/stop, etc.) of whether the material being tested satisfies any applicable requirements. As another example, the mobile device 40 may display a confidence level indicative of how likely it is that the material being tested is genuine (e.g., the system is 99% confident that the prescription medication is genuine and not counterfeit). As another example, the mobile device may display a graphical representation of the expected and/or actual spectral responses of the material being tested. Accordingly, the information displayed by the mobile device 40 may be varied from situation to situation, or may be standardized depending on anticipated needs.

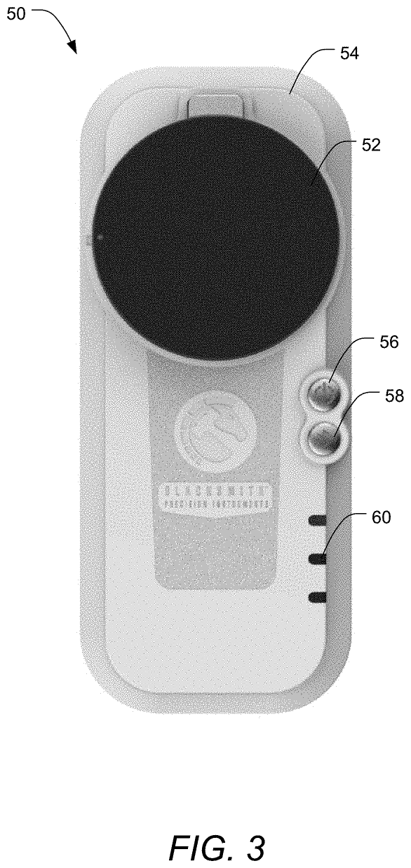

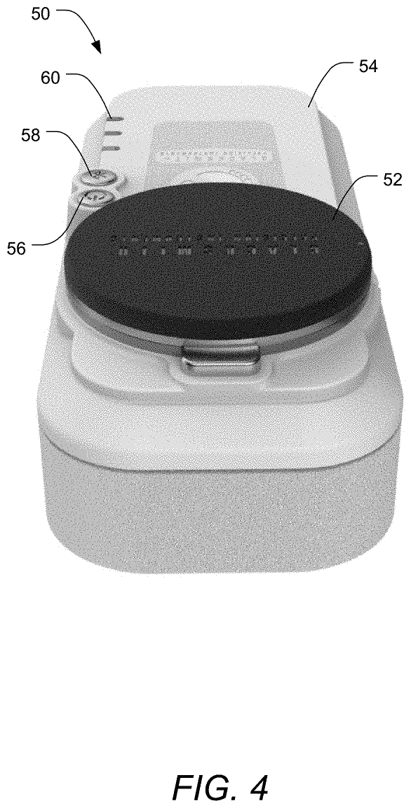

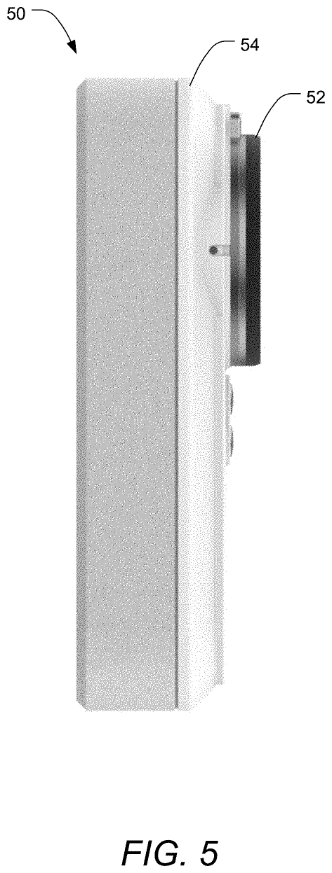

FIGS. 3-5 show various views of an exemplary embodiment of the mobile spectrum analyzer 50, with a protective sensor calibrator cap 52 affixed thereto. In some such embodiments, the sensor calibrator cap 52 protects the sensor of the mobile spectrum analyzer 50, and also serves to retain a calibration pad (not shown in FIGS. 3-5) that can be used to maintain calibration of the mobile spectrum analyzer 50, such as on startup. The mobile spectrum analyzer 50 has a body 54 that is dimensioned to be held by the user and to contain operative components of the mobile spectrum analyzer 50, such as a battery or other power supply, a wireless or wired communication device, a near-infrared light source, a mid-infrared light source, a light source for Raman spectroscopy, a sensor, any other applicable electrical and computer components (see, e.g., FIG. 1), and/or any other components of the mobile spectrum analyzer 50. In the example of FIGS. 3-5, and without being limiting, the dimensions of the body (which can be any suitable size) are approximately 120 mm by approximately 50 mm by approximately 30 mm, whereby the mobile spectrum analyzer 50 may readily fit within and be carried by an average human hand. Indeed, the mobile spectrum analyzer 50 of this embodiment is extremely compact, as allowed (in some embodiments) by the shunting of resources and analysis off of the mobile spectrum analyzer 50 to the mobile device 40 and/or remote computing resources over the network 38.

The illustrative embodiment of the mobile spectrum analyzer 50 includes a power button 56 and a Bluetooth pairing button 58, which allow the mobile spectrum analyzer 50 to be powered on and paired (via a Bluetooth connection) to the mobile device 40. The illustrated mobile spectrum analyzer 50 also includes three indicator lights 60 (more or fewer (and/or any other suitable indicator) may be used in alternate embodiments) that may be used to convey basic information to the user of the mobile spectrum analyzer 50 (e.g., information such as battery/charging status, Bluetooth pairing status, device warm-up and readiness status, and the like). While not shown in the Figures, the mobile spectrum analyzer 50 may include one or more ports, such as a communications port for a wired communications connection, a power and/or charging port, such as a micro USB port or USB-C port, and the like. Alternatively, the mobile spectrum analyzer 50 may receive power/be charged via a wireless/induction charger, as is known in the art.

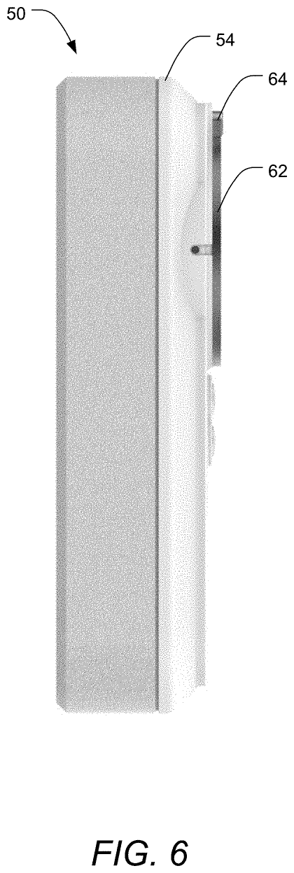

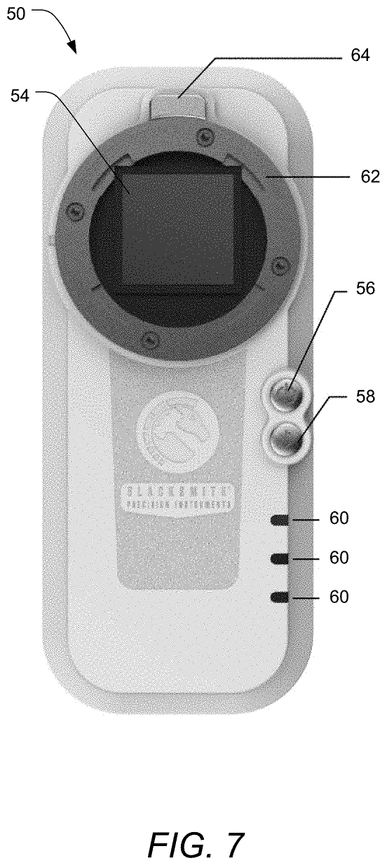

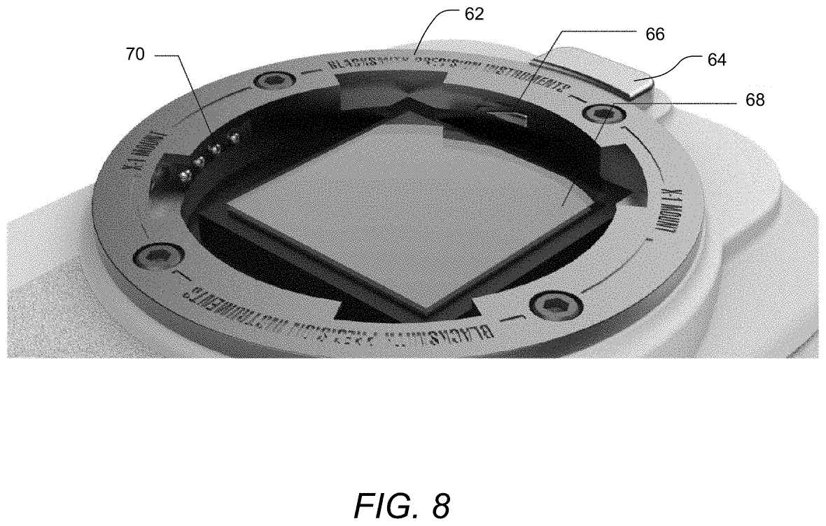

FIGS. 6-8 show views of a representative embodiment of the mobile spectrum analyzer 50 with the calibrator cap 52 removed. With the calibrator cap 52 removed, a mounting ring 62 is exposed. The mounting ring 62 serves to secure the calibrator cap 52 or alternatively a testing cap to the body 54 during a testing or calibration procedure. The calibrator cap 52 or testing cap is inserted into the mounting ring 62 and turned so as to securely engage the mounting ring 62. A release button 64 may be manipulated to cause a spring release latch 66 (see FIG. 8) to release when the calibrator cap 52 or testing cap is to be removed from the mounting ring 62.

In accordance with some embodiments, the mounting ring 62 encircles a sensor 68, which in one illustrated embodiment comprise a low-cost FT-NIR spectral sensor. In other embodiments, the sensor 68 may be a MT-NIR spectral sensor, a Raman spectral sensor, and/or any other suitable spectral sensor. In the illustrated embodiment, the sensor 68 may be a NeoSpectra sensor manufactured by Si-Ware Systems of La Canada, Calif. The NeoSpectra sensor is a low-cost, miniaturized spectral sensor based on micro electro mechanical systems (MEMS) technology. Such sensors are constructed of low-cost, robust, permanently aligned, and highly reproducible components, and are therefore ideal for use in the mobile spectrum analyzer 50. The sensor 68 in the illustrated embodiment of the mobile spectrum analyzer 50 can detect near-infrared light with very high detail range from 1,350-2,500 nm, with the power spectral density over that spectral range exceeding one tenth of the maximum power spectral density. Over a two-second scan time at 2,050 nm, the typical signal-to-noise ratio is approximately 2,000:1. The system is able to operate over a temperature range of approximately −5° C. to 40° C., achieves a resolution at about 1,550 nm of about 16 nm as measured by the FWHM criterion, has a wavelength accuracy at about 1,400 nm and temperature below about 40° C. of +/− 1.5 nm, and has a wavelength repeatability at about 1,400 nm and about 0.5 absorbance units (Au) of +/− 0.1 nm. Accordingly, the system can be used for highly repeatable measurements.

The mounting ring 62 may also enclose one or more contact pins 70 (and/or other sensors or mechanisms) that can be used to detect that a cap is fully mounted to the mounting ring 62. The various caps can permit universal substances to be tested by the mobile spectrum analyzer 50, including solids, powdered material, gels, fluids, and/or liquid material. Because essentially any material can be tested using the mobile spectrum analyzer 50, the system is not limited to use in any particular industry or application. Envisioned uses include uses with respect to the pharmaceutical industry, both during any stage of manufacture as a quality control assurance, as well as at later points such as at the point of sale/distribution or by the end user to discern between genuine product and counterfeit product as well as to verify continued potency in situations where medication is subject to loss of potency over time. Other envisioned uses include wineries, mining, oil and gas, food and beverage industries, and a variety of other industries that could benefit from a system that can help authenticate and identify any raw material makeup in a non-destructive fashion.

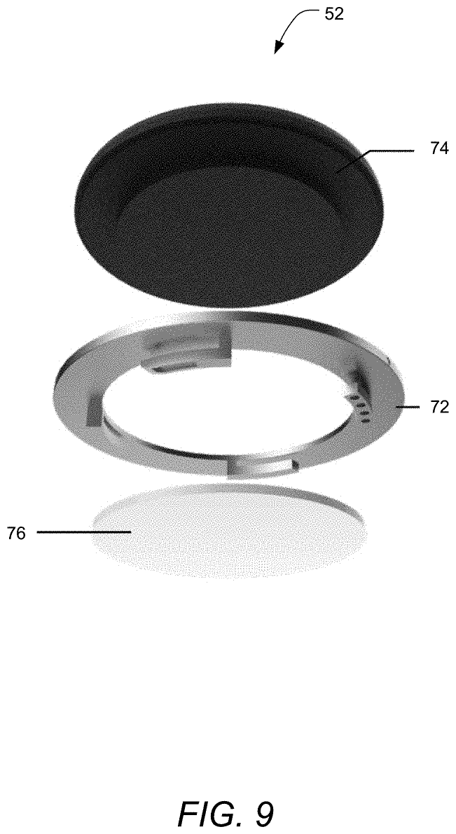

FIGS. 9-11 illustrate exploded views of some embodiments of various caps for use with the mobile spectrum analyzer 50. FIG. 9 illustrates the calibrator cap 52, which includes a locking ring 72 adapted to engage with the mounting ring 52. The calibrator cap 52 also includes an obscuring cover 74 and a calibration pad 76, such that when the calibrator cap 52 is mounted to the mounting ring 62, the calibration pad 76 is proximate the sensor 68, and the obscuring cover 74 prevents entry of external light. In accordance with some embodiments, the calibrator cap 52 is configured to be left on the mobile spectrum analyzer 50 when the mobile spectrum analyzer 50 is not in use to protect the sensor. Additionally, the calibrator cap is (in some embodiments) left on when the device is turned on and until the device is warmed up to let the mobile spectrum analyzer 50 calibrate the sensor 68. When the calibrator cap 52 is not in use on the mobile spectrum analyzer 50, a protective cover should be used to cover and protect the calibration pad 76, which should not be touched.

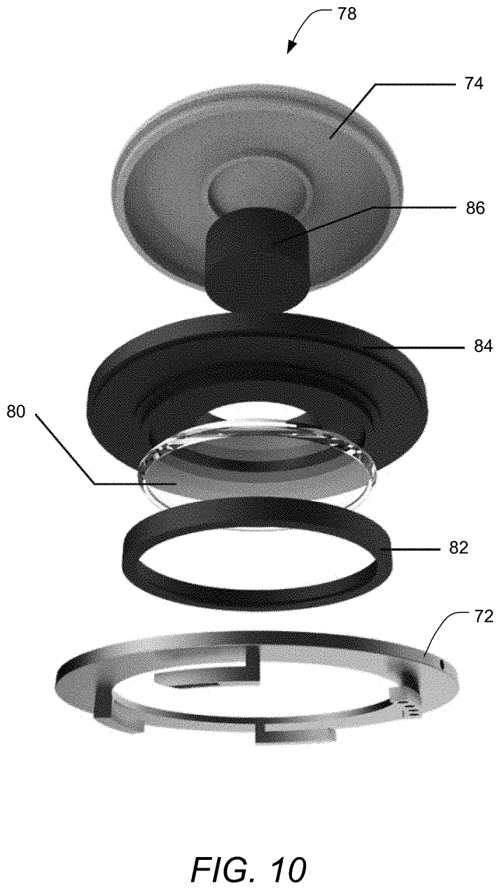

FIG. 10 illustrates a representative embodiment of a pill tray 78, which is one example of a testing cap. In such embodiment, the pill tray 78 also includes the locking ring 72 and a version of the obscuring cover 74, which serve similar purposes to the locking ring 72 and obscuring cover 74 of the calibrator cap 52. The pill tray 78 may be used to scan solid (and/or any other suitable) substrates. In the illustrated embodiment, the pill tray 78 can accept any pill smaller than about 15 mm in diameter, otherwise the pill to be tested can be crushed into a powder form (or otherwise reduced in size) and tested in the pill tray 78. In some cases, the pill tray includes a borosilicate sheet 80 retained by a retainer 82. The borosilicate sheet 80 is transparent to near-infrared light, and the solid or powdered material being tested resides within a cavity of a tray 84 located immediately above the borosilicate sheet 80. A foam (and/or any other suitable) insert 86 is affixed (in some cases) to the bottom of the obscuring cover 74, and further serves to ensure that outside light does not interfere with the reading taken by the sensor 68. The borosilicate sheet 80 should be kept clean and fingerprint free, and is covered by a protective cover when not in use.

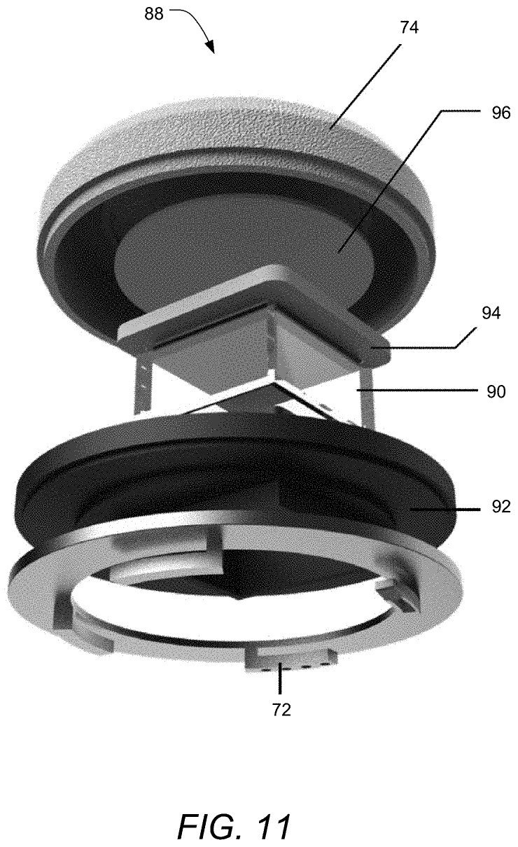

FIG. 11 illustrates a representative embodiment of a liquid tray 88, which is another example of a testing cap. The liquid tray 88 also includes the locking ring 72 and another version of the obscuring cover 74, which serve similar purposes to the locking ring 72 and the obscuring cover 74 of the other caps discussed previously. The liquid tray 88 may be used to scan liquid substances. In the illustrated embodiment, the liquid tray 88 includes a vial 90 which is shaped and adapted to be received within a vial tray 92. The vial 90 is formed with at least a borosilicate (or other material transparent to near-infrared light) bottom, and is adapted to receive a liquid sample therein. The vial 90 can be closed by a vial cover 94, and the entire vial assembly can be secured within the liquid tray 88 by a foam insert 96 affixed to the bottom of the obscuring cover 74.

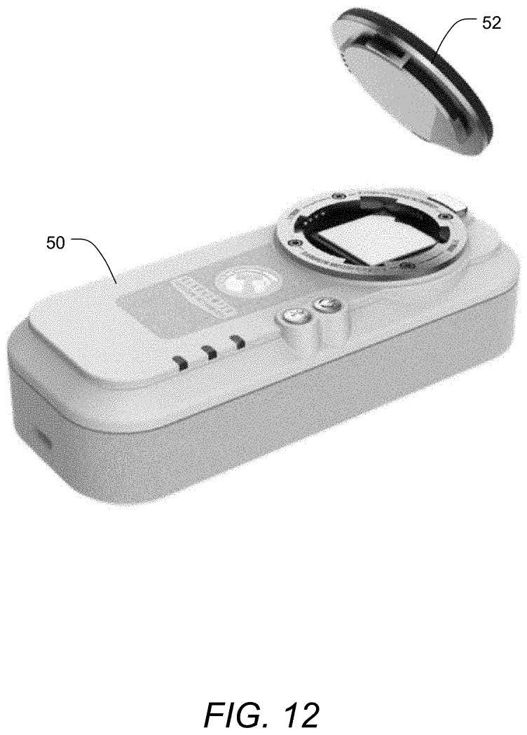

FIGS. 12-14 illustrate steps in preparing the mobile spectrum analyzer 50 for use in testing various substances. Once the mobile spectrum analyzer 50 is turned on, warmed up, and calibrated, which may be indicated, for example, by one or more of the indicator lights 60 or by a notification on a paired mobile device 40 (and/or in any other suitable manner), the calibrator cap 52 is removed as shown in FIG. 12, and the calibration pad 76 is covered to prevent dirtying of the calibration pad 76.

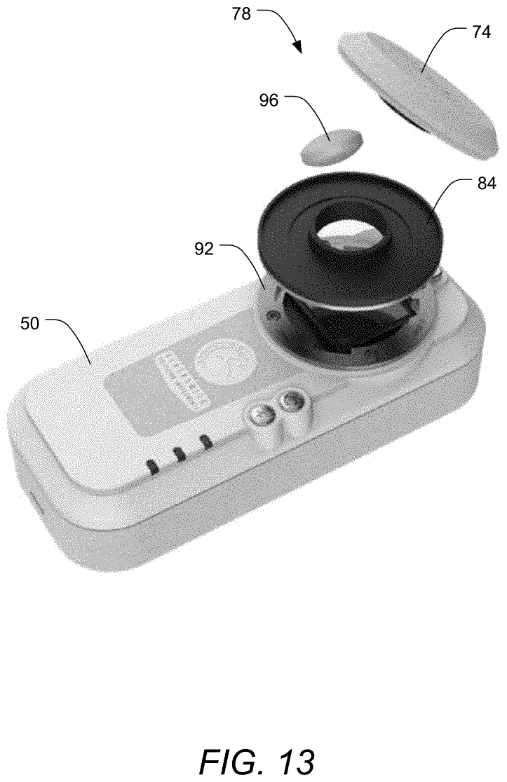

In accordance with some embodiments, if a solid or powered material is to be tested, the pill tray 78 is mounted to the mounting ring 62, as shown in FIG. 13, whereupon a pill 96 (or some other solid or powdered material) may be placed within the cavity of the tray 84, and the obscuring cover 74 placed to fully assemble the pill tray 78. Once the pill tray 78 is fully assembled on the mobile spectrum analyzer 50 with the pill 96 or other material to be tested therein, the scan may be commenced, such as using a command on an app running on a paired mobile device 40.

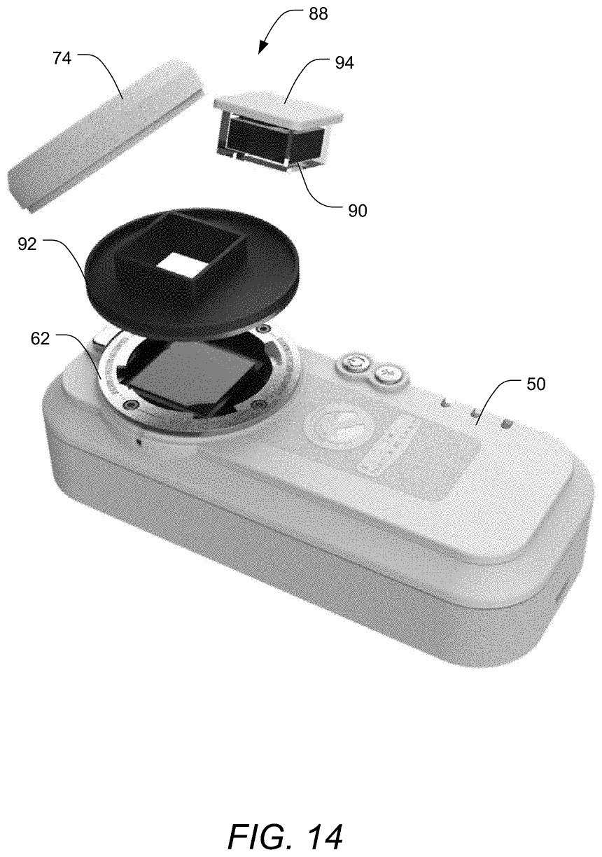

In accordance with some embodiments, if a liquid material is to be tested, the liquid tray 88 is mounted to the mounting ring 62, as shown in FIG. 14, whereupon a liquid may be placed within the vial 90, and the vial cover 94 used to cover the vial 90. Then the vial 90 is placed within a cavity of the vial tray 92, and the obscuring cover 74 is placed to fully assemble the liquid tray 88. Once the liquid tray 88 is fully assembled on the mobile spectrum analyzer 50 with the liquid to be tested therein, the scan may be commenced, such as using a command on an app running on a paired mobile device 40.

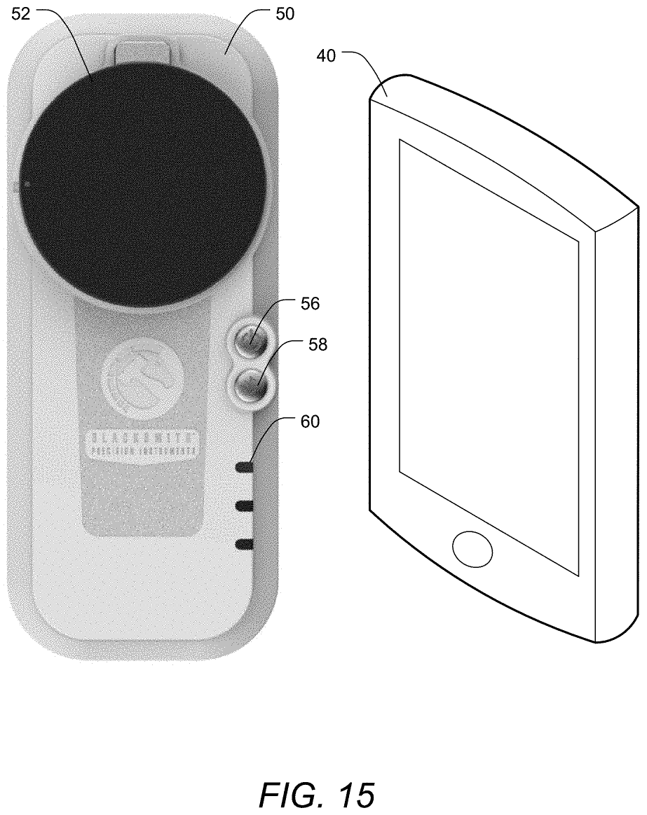

FIG. 15 illustrates the mobile spectrum analyzer 50 proximate an example embodiment of the mobile device 40. To begin a test, the user would (in some embodiments) operate the power button 56 to turn the device on (with the calibrator cap 52 in place), and thereafter could monitor one or more of the indicator lights 60 to ensure that startup is proceeding as normal. At an appropriate time, the user would operate the Bluetooth pairing button 58 to pair the mobile spectrum analyzer 50 with the mobile device 40, whereupon further operational commands could be provided using an input device of the mobile device 40, such as using a touch screen. Further use of the system would occur as discussed with respect to FIGS. 12-14.

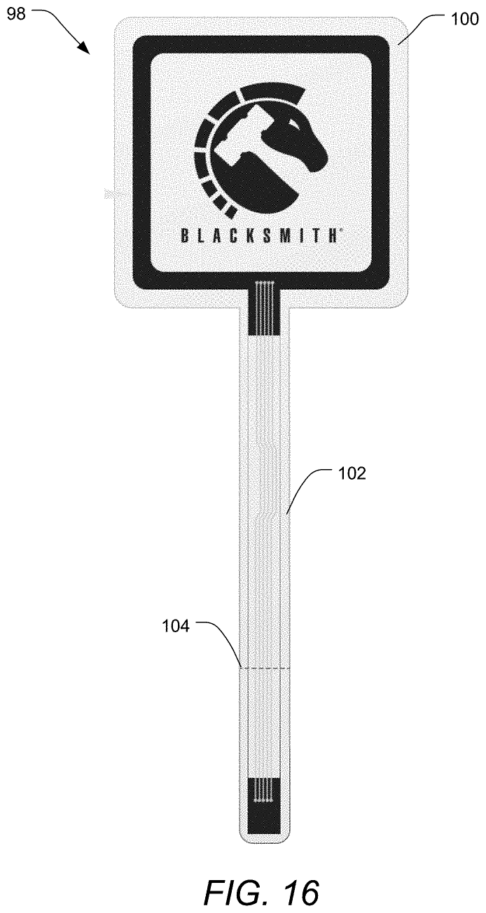

As mentioned previously, NFC and other tags affixed to products could be used with embodiments of the invention to ensure that medications (and/or other materials) are genuine and not counterfeit. Accordingly, FIG. 16 illustrates a representative NFC tag 98. As discussed previously, the NFC tag 98 could be programmed or manufactured to include accessible information relevant to a medication (or other product) to which the NFC tag 98 is affixed. By way of example with respect to medications, the NFC tag 98 could include accessible information such as information related to expected FT-NIR (or FT-MIR, or Raman) scan results of container contents if the contents are genuine, an expiration date of the container contents, a link to further information regarding the container contents, information relating to a quantity contained in the container, and/or any other relevant information.

While the NFC tag 98 can comprise any suitable component or characteristic, in accordance with some embodiments, the NFC tag 98 has a body 100 and a leg 102 extending from the body 100. The leg 102 includes wiring that the NFC tag 98 is able to report as being continuous or broken. In some cases, the leg 102 also includes a break point 104 at which the leg 102 is naturally weaker. The reverse side of the leg 102 is affixed to the medication (and/or other) container such that the break point 104 naturally aligns with the bottom edge of a removable cap (and/or any other suitable portion) of the container, such that the container cannot be opened without breaking the wiring at the break point 104, whereupon the NFC tag 98 would report that the medication had been opened. The wiring and break point 104 accordingly serve (in some cases) as a tamper-proofing mechanism.

Some competing tags have been subject to counterfeiting. In this regard, counterfeiters are able to produce similar NFC tags such that even if a medicine container is tampered with and genuine medicine replaced with counterfeit medication, the consumer is unable to tell, because the counterfeiter replaces the damaged competing NFC tag with a replacement counterfeit NFC tag. In contrast, some embodiments of the NFC tag 98 are further proofed against counterfeiting, however, because they contain information that uniquely identifies the medication (or other material) contained within the container that allows the mobile spectrum analyzer 50 to be used to verify genuineness of the medication (and/or other material).

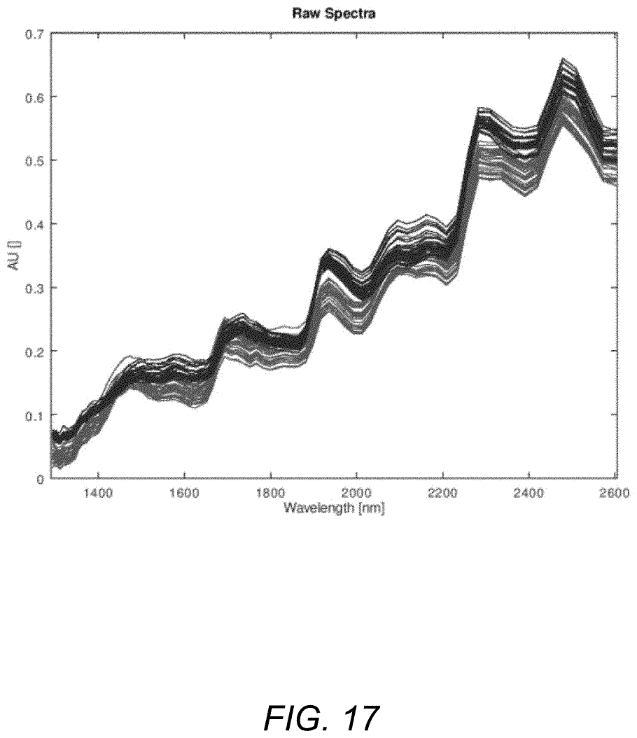

For purposes of verification of the genuineness of the medication (and/or other material) contained in the container, the information related to the expected FT-NIR scan (and/or other suitable scan) results is of great importance. FIG. 17 illustrates what such information might look like once the information is obtained from the NFC tag 98 by the mobile device 40 and after the information is interpreted by the app running on the mobile device. FIG. 17 illustrates the unique spectral identifier associated with genuine medication as an absorption waveform over the operational wavelengths of the mobile spectrum analyzer 50. This information can be used by the system as part of a non-destructive test of as much of the medication as the pharmacist or end user wishes to test.

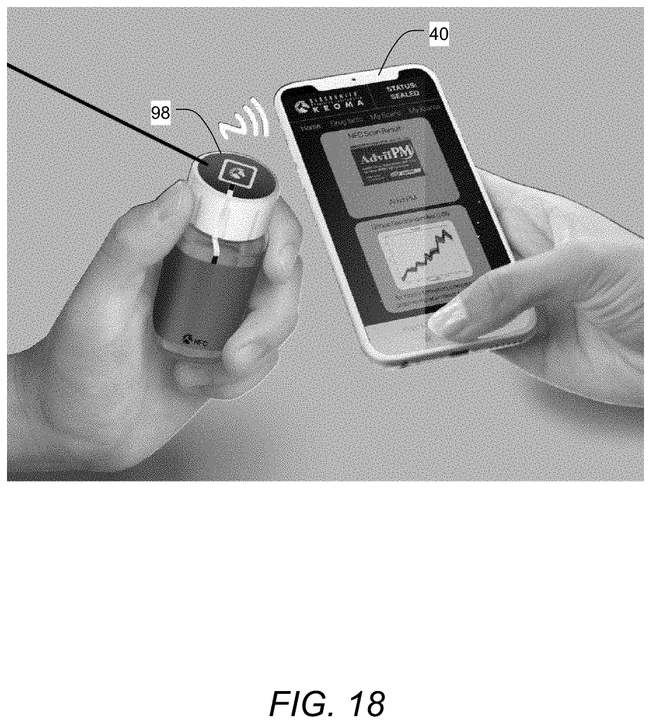

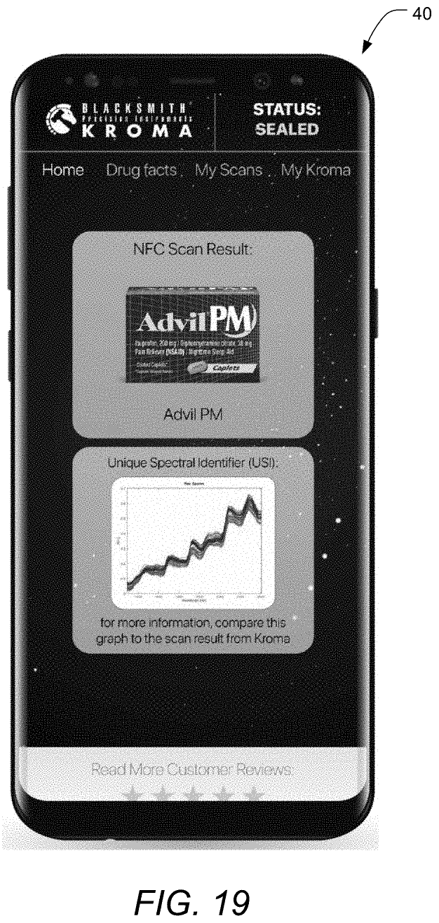

FIG. 18-22 show the steps and possible results of this process. As illustrated in FIG. 18, the NFC tag 98 of the medication is brought within NFC range of the mobile device 40, whereupon the mobile device 40 is operated to obtain a scan of the NFC data. After the NFC data is obtained from the NFC tag 98, the app operating on the mobile device 40 may display relevant information as shown in FIG. 19, which shows an identification of what the medication is as well as the unique spectral identifier that would be the expected scan result if the medication contained in the container is in fact genuine. The mobile device 40 also shows that the medication is still sealed, as the container has not been opened and the break point 104 of the leg 102 has not been broken.

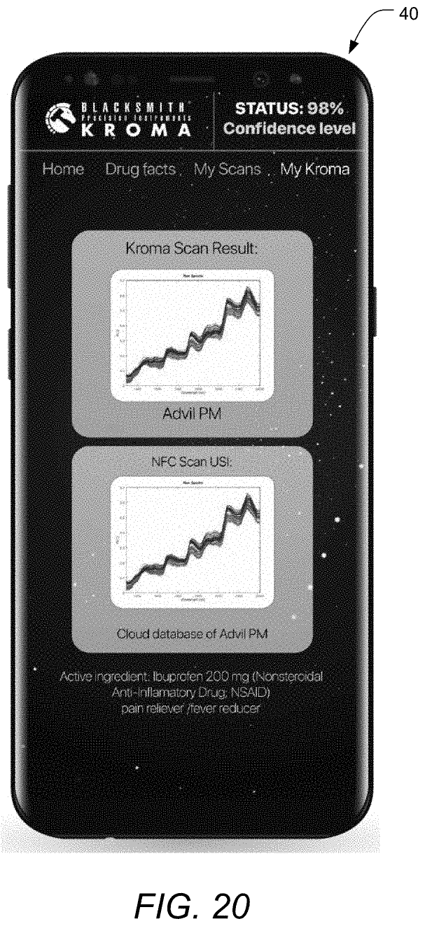

The user could then perform a scan of the medication using the mobile spectrum analyzer 50. After the scan is complete, the display of the mobile device 40 might be updated to show the scan results from the mobile spectrum analyzer compared with the expected scan results for genuine product, such as is shown in FIG. 20. In the illustrated example, the medication appears to be genuine and still potent, so the pharmacist could dispense the medication with confidence and could show the results to customers to assure them that they are receiving genuine and/or potent products, or the end user could take the medication as directed with confidence. As discussed previously, the information related to the scan results could be displayed in any other desirable fashion, such as a binary result (genuine/counterfeit, pass/fail, go/stop, etc.) or as a confidence level with respect to whether the product is genuine or not, etc., as is displayed in the upper right of the display of the mobile device 40 in FIG. 20.

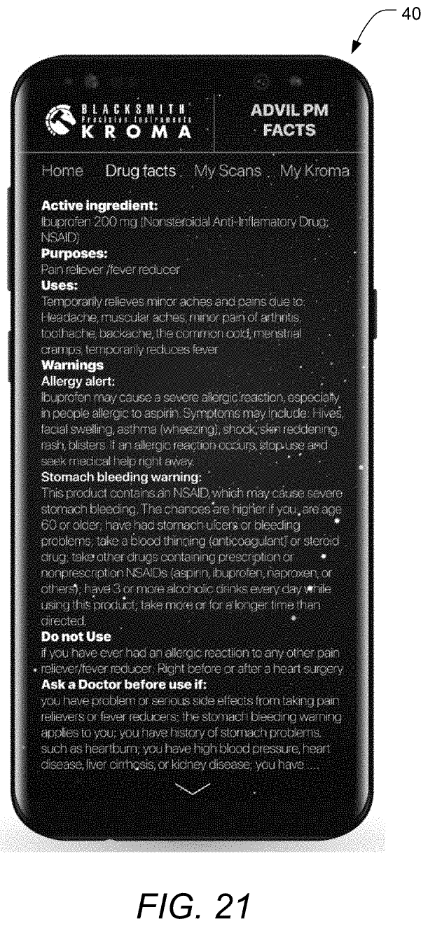

In some embodiments, the user of the mobile device 40 may be provided an opportunity to view additional information relating to the medication, as is illustrated in FIG. 21. In this Figure, the mobile device 40 has been manipulated to display drug facts relating to the product identified by the NFC tag 98. Such information may come from the NFC tag 98 itself, or may be obtained over the network 38 using information contained on the NFC tag 98. There is no particular limit to the information that may be displayed by the mobile device 40 either before or after a scan by the mobile spectrum analyzer 50.

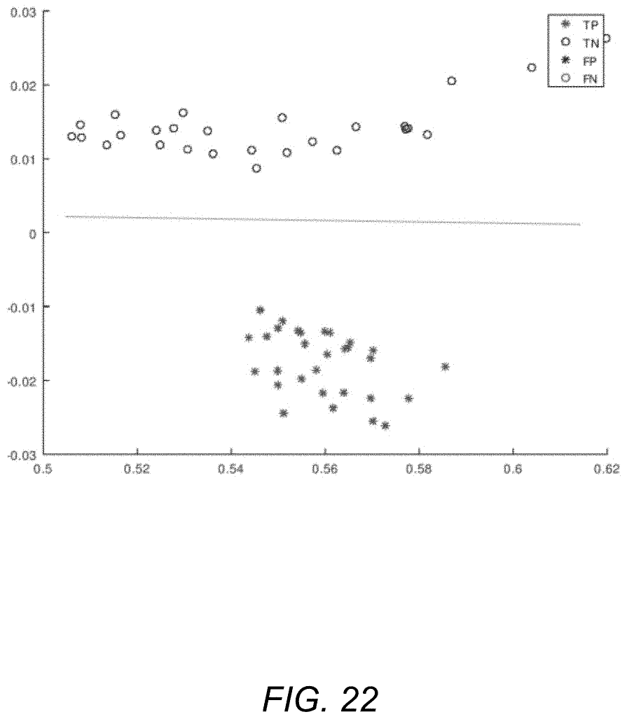

FIG. 22 illustrates one example of a display that might be displayed to the user by the mobile device 40 in the event there was a mismatch between the expected unique spectral identifier and the scan results obtained by the mobile spectrum analyzer. As may be seen in FIG. 22, there is a significant mismatch between the grouping of expected results and the grouping of actual results. As may be appreciated from FIG. 22, a user viewing such results would be instantly aware that the tested medication is not genuine or is no longer potent and should not be consumed.

Accordingly, embodiments of the invention provide mobile FT-NIR, FT-MIR, and/or

Raman spectral analysis systems that are compact and able (in accordance with some embodiments) to operate with a self-contained power supply. The systems are reliable and lend themselves to use in monitoring against counterfeiting of materials including, especially, drugs and medications in ways not previously available.

Embodiments of the invention may be used in conjunction with a variety of industries and with respect to a variety of quality assurance/quality control steps in the manufacturing, distribution, and consumption phases of products' life cycles. During the manufacture of a product, whether drug/medication or any other product, a group of ingredients are used to create a compounded final product with a specific chemical structure/composition. As part of the final quality control or quality assurance process in the manufacturing phase, a spectral analysis system, which may be an embodiment of the mobile spectrum analyzer 50 or may be another dedicated spectrometer, is used to collect spectral data (NIR, MIR, and/or Raman) of the final product that is specific to the chemical structure or composition.

The spectral data may then be mathematically processed to produce the unique identifier that is unique to the product's structure or composition. In some embodiments, the unique identifier may be specific to a particular product type, while in other embodiments, the unique identifier may be specific to a particular batch of product.

The unique identifier or information allowing creation of the unique identifier may be burned into a NFC identification tag or other radio or optical tag, or may be stored on the server 48 for remote access, as discussed above and as directed by information burned into the appropriate tag affixed to the product or its packaging. The product is then shipped out to its destination location with the appropriate tag affixed.

Any party at any stage in the distribution chain can use the tag to obtain the unique identifier, and can use a spectral scan of the product to verify authenticity of the product, e.g., by using an embodiment of the mobile spectrum analyzer 50 or another dedicated spectrometry device. An end user of the product can also check for authenticity by using a custom mobile application that utilizes the unique identifier information burned into the applicable tag or accessed by scanning the applicable tag.

The present invention may be embodied in other specific forms without departing from its spirit or essential characteristics. The described embodiments are to be considered in all respects only as illustrative and not restrictive. The embodiments described herein can be combined in any suitable manner. Additionally, the term step is not to be construed as being limiting in any suitable manner. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A mobile spectral analysis system comprising:
a mobile spectrum analyzer having a self-contained power supply including a battery; and
a mobile computing device communicative connected to the mobile spectrum analyzer and operating an application configured to control scanning by the mobile spectrum analyzer and to receive scan data from the mobile spectrum analyzer;
whereby processing of the scan data from the mobile spectrum analyzer is moved off of the mobile spectrum analyzer such that the mobile spectrum analyzer is made small and light enough to be readily handheld.

2. The mobile spectral analysis system of claim 1, wherein the mobile spectrum analyzer and the mobile computing device are connected by a wireless connection.

3. The mobile spectral analysis system of claim 1, wherein the mobile computing device is communicatively coupled to remote computing resources over a network, such that at least some processing of the scan data from the mobile spectrum analyzer is moved off the mobile device to the remote computing resources.

4. The mobile spectral analysis system of claim 3, wherein the remote computing resources comprise a database of scan data associated with known materials, and wherein processing of the scan data from the mobile spectrum analyzer by the remote computing resources comprises performing a comparison of entries from the database of scan data and the scan data from the mobile spectrum analyzer.

5. The mobile spectral analysis system of claim 1, further comprising a tag selected from the group consisting of a radio-frequency identification (RFID) tag, a near field communication (NFC) tag, and an optical tag, the tag being affixed to a container containing a material to be tested, the tag containing information identifying a unique spectral identifier that should be the result of the scan data from the mobile spectrum analyzer if the material within the container is genuine.

6. The mobile spectral analysis system of claim 5, wherein the mobile computing device comprises a tag reader adapted to read the tag.

7. The mobile spectral analysis system of claim 6, wherein the mobile computing device is configured to obtain the information identifying the unique spectral identifier and perform a comparison between the unique spectral identifier and the scan data from the mobile spectrum analyzer and provide an indication regarding whether the material within the container is genuine.

8. The mobile spectral analysis system of claim 7, wherein the indication regarding whether the material within the container is genuine comprises a binary indication.

9. The mobile spectral analysis system of claim 7, wherein the indication regarding whether the material within the container is genuine comprises a graphical comparison between the unique spectral identifier and the scan data from the mobile spectrum analyzer.

10. The mobile spectral analysis system of claim 7, wherein the indication regarding whether the material within the container is genuine comprises an assurance level of the probability that the material within the container is genuine.

11. The mobile spectral analysis system of claim 6, wherein the NFC tag comprises:
a structure adapted to be broken if the container is opened; and
a capability of notifying the mobile computing device when the structure adapted to be broken has been broken.

12. The mobile spectral analysis system of claim 1, wherein the mobile spectrum analyzer comprises:
a spectrum analyzer selected from the group consisting of a Fourier transform near-infrared (FT-NIR) spectrum analyzer, a Fourier transform mid-infrared (FT-MIR) spectrum analyzer, and a Raman spectrum analyzer;
a light source selected from the group consisting of a FT-NIR-compatible light source, a FT-MR-compatible light source, and a Raman-spectroscopy-compatible light source; and
a sensor selected from the group consisting of a FT-NIR-compatible sensor, a FT-MIR-compatible sensor, and a Raman-spectroscopy-compatible sensor.

13. The mobile spectral analysis system of claim 1, wherein the mobile spectrum analyzer comprises:
a spectrum analyzer selected from the group consisting of a Fourier transform near-infrared (FT-NIR) spectrum analyzer and a Fourier transform mid-infrared (FT-MIR) spectrum analyzer;
a light source selected from the group consisting of a FT-NIR-compatible light source and a FT-MIR-compatible light source; and
a sensor selected from the group consisting of a FT-NIR-compatible sensor and a FT-MIR-compatible sensor.

14. A method for using a mobile spectrum analyzer communicatively connected with a mobile computing device to nondestructively conduct a spectral analysis of a material, the method comprising steps of:
communicatively coupling a mobile spectrum analyzer having a self-contained power supply including a battery to a mobile computing device;
placing a material to be analyzed within a test chamber of the mobile spectrum analyzer;
exposing the material within the test chamber of the mobile spectrum analyzer to light within a selected electromagnetic spectrum;
detecting a spectrum of light returned from the material using a sensor of the mobile spectrum analyzer;
communicating information regarding the spectrum of light detected by the sensor of the mobile spectrum analyzer to the mobile computing device; and
processing the information regarding the spectrum of light detected by the sensor of the mobile spectrum analyzer to generate information regarding the material within the test chamber of the mobile spectrum analyzer.

15. The method as recited in claim 14, further comprising a step of using the mobile computing device to obtain information regarding the material to be analyzed from a tag affixed to packaging originally containing the material to be analyzed.

16. The method as recited in claim 15, wherein the tag comprises a tag selected from the group consisting of a radio-frequency identification tag, a near field communication tag, a one-dimensional optical tag, and a two-dimensional optical tag.

17. The method as recited in claim 14, wherein the information regarding the material to be analyzed comprises an intended unique spectral identifier associated with a material that is supposed to be contained within the packaging, and wherein the step of processing the information regarding the spectrum of light detected by the sensor of the mobile spectrum analyzer to generate information regarding the material within the test chamber of the mobile spectrum analyzer comprises comparing an actual unique spectral identifier associated with the material within the test chamber with the intended unique spectral identifier to verify authenticity of the material within the test chamber.

18. The method as recited in claim 14, wherein the step of processing the information regarding the spectrum of light detected by the sensor of the mobile spectrum analyzer to generate information regarding the material within the test chamber of the mobile spectrum analyzer is performed at least in part by the mobile computing device.

19. The method as recited in claim 14, wherein the step of processing the information regarding the spectrum of light detected by the sensor of the mobile spectrum analyzer to generate information regarding the material within the test chamber of the mobile spectrum analyzer is performed at least in part by a remote computing resource in communication with the mobile computing device.

20. A method for verifying authenticity of a material stored in a sealed container, comprising:
using a spectrum analyzer to determine original spectral data associated with an original material to be contained in a sealed original container;
assigning an original unique spectral identifier to the spectral data;
storing the original unique spectral identifier on a network-connected server system along with the original spectral data;
placing the original material into an original container;
burning information identifying the original spectral data and the original unique spectral identifier into an original sealing tag;
sealing the container with the original sealing tag;
receiving, over the network, a request to verify authenticity of material in an endpoint container, the request comprising information identifying:
an endpoint unique spectral identifier obtained from an endpoint tag affixed to and sealing the endpoint container; and
endpoint spectral data obtained from the endpoint tag; and
sending, over the network, a response to the request selected from the group consisting of:
a verification that the material in the endpoint container is authentic if the endpoint unique spectral identifier and the endpoint spectral data match the original unique spectral identifier and the original spectral data; and
an indication that the material in the endpoint container is not authentic if either of the endpoint unique spectral identifier or the endpoint spectral data does not match the original unique spectral identifier or the original spectral data.
